(19) United States
(12) Patent Application Publication
(10) Pub. No.: US 2020/0272585 A1
(43) Pub. Date: Aug. 27, 2020

(54) MEMORY CONTROLLER AND MEMORY SYSTEM INCLUDING THE MEMORY CONTROLLER

(71) Applicant: SK hynix Inc., Icheon-si Gyeonggi-do (KR)

(72) Inventors: Joo Young KIM, Seoul (KR); Yong Sang PARK, Seongnam-si Gyeonggi-do (KR); Jae Hyeok JANG, Icheon-si Gyeonggi-do (KR); Young Jae JIN, Seoul (KR)

(73) Assignee: SK hynix Inc., Icheon-si Gyeonggi-do (KR)

(21) Appl. No.: 16/600,823

(22) Filed: Oct. 14, 2019

(30) Foreign Application Priority Data
Feb. 25, 2019 (KR) 10-2019-0022076

(51) Int. Cl. G06F 13/16

(52) U.S. Cl. CPC G06F 13/1678; G06F 13/1684; G06F 13/1673

(57) ABSTRACT

There are provided a memory controller and a memory system having the same. The memory controller is included in the memory system for storing data and transmits data between the memory system and a host system. The memory controller includes: a buffer including a plurality of blocks for storing the data, the buffer inputting or outputting the data through a first bus having a first data width or a second bus having a second data width; and a data width controller for mapping the blocks according to the first and second data widths.

### CROSS-REFERENCE TO RELATED APPLICATION

The present application claims priority under 35 U.S.C. § 119(a) to Korean patent application number 10-2019-0022076, filed on Feb. 25, 2019, in the Korean Intellectual Property Office, the entire disclosure of which is incorporated herein by reference.

### BACKGROUND

### 1. Technical Field

The present disclosure generally relates to a memory controller and a memory system having the same, and more particularly, to a memory controller related to mapping and transmitting data according to various data widths of a bus, and a memory system including the memory controller.

### 2. Related Art

With increasing demand for high capacity and low power consumption for memory devices, research has been conducted on next-generation memory devices that have a nonvolatile characteristic and do not require refresh operations. Such next-generation memory devices are required to have the high density of a Dynamic Random Access Memory (DRAM), the nonvolatile characteristic of a flash memory, the high speed of a Static RAM (SRAM), and the like. Examples of the next-generation memory devices, which can meet the above-described requirements, may include a Phase Change RAM (PCRAM), a Nano Floating Gate Memory (NFGM), a Polymer RAM (PoRAM), a Magnetic RAM (MRAM), Ferroelectric RAM (FeRAM), A Resistive RAM (RRAM), and the like.

Recently, as the kind and usage of memory device are diversified, the data width used in a memory system including the memory device is also diversified.

### SUMMARY

In accordance with an aspect of the present disclosure, there is provided a memory system comprising: a memory controller configured for storing data and transmitting data between the memory system and a host system, the memory controller comprising: a buffer including a plurality of blocks configured for storing the data, the buffer configured for inputting or outputting the data through a first bus having a first data width or a second bus having a second data width; and a data width controller configured to map the blocks according to the first and second data widths.

In accordance with another aspect of the present disclosure, there is provided a memory system comprising: a sharing memory system configured to store data; a processor configured to control the sharing memory system in response to a request received from a host system, and store program data or read data; and an Advanced eXtensible Interface (AXI) controller configured to transmit and receive data to and from the sharing memory system and the processor through a first bus, wherein the processor: is connected to the host system through a second bus; and changes a transmission order of the program data or the read data according to data widths of the first and second buses.

### BRIEF DESCRIPTION OF THE DRAWINGS

Examples of embodiments will now be described hereinafter with reference to the accompanying drawings; however, they may be embodied in different forms and should not be construed as limited to the embodiments set forth herein.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a memory system in accordance with an embodiment of the present disclosure.

FIG. 2 is a diagram illustrating a sharing memory system shown in FIG. 1.

FIG. 3 is a diagram illustrating a processor shown in FIG. 1.

FIG. 4 is a diagram illustrating an operation controller shown in FIG. 3.

FIG. 5 is a diagram illustrating a data width controller shown in FIG. 3.

FIG. 6 is a diagram illustrating an operating method of a data transmission order controller shown in FIG. 5.

FIG. 7 is a diagram illustrating a buffer shown in FIG. 3.

FIG. 8 is a diagram illustrating a data transmission component shown in FIG. 3.

FIG. 9 is a diagram illustrating a data transmission order in accordance with an embodiment of the present disclosure.

FIGS. 10 and 11 are diagrams illustrating a data transmission method in accordance with a first embodiment of the present disclosure.

FIGS. 12 to 14 are diagram illustrating a data mapping and transmission method by using the buffer and a host system in accordance with the first embodiment of the present disclosure.

FIGS. 15 and 16 are diagrams illustrating a data transmission method in accordance with a second embodiment of the present disclosure.

FIGS. 17 to 19 are diagram illustrating a data mapping and transmission method by using the buffer and the host system in accordance with the second embodiment of the present disclosure.

FIG. 20 is a diagram illustrating a data mapping and transmission method by using the buffer and the host system in accordance with a third embodiment of the present disclosure.

FIGS. 21 and 22 are diagrams illustrating a data transmission method in accordance with a fourth embodiment of the present disclosure.

FIGS. 23 to 25 are diagrams illustrating a data mapping and transmission method by using the buffer and the host system in accordance with the fourth embodiment of the present disclosure.

### DETAILED DESCRIPTION

In the present disclosure, advantages, features and methods for achieving them will become more apparent after a reading of the following examples of embodiments taken in conjunction with the drawings. The present disclosure may, however, be embodied in different forms and should not be construed as being limited to the embodiments set forth herein.

In the entire specification, when an element is referred to as being “connected” or “coupled” to another element, it can be directly connected or coupled to the another element or be indirectly connected or coupled to the another element with one or more intervening elements interposed therebetween. In addition, when an element is referred to as “including” a component, this indicates that the element may further include another component instead of excluding another component unless there is different disclosure.

Embodiments may provide a memory controller capable of efficiently transmitting data according to various data widths, and a memory system having the memory controller.

In accordance with an embodiment, blocks in which data is stored are mapped according to a data width, and the mapped blocks are transmitted to be suitable for the data width, so that buses having various data width can be used in the memory system.

FIG. 1 is a diagram illustrating a memory system in accordance with an embodiment of the present disclosure.

Referring to FIG. 1, the memory system 1000 may store data received from a host system 2000, or output stored data to the host system 2000.

The memory system 1000 may include a sharing memory system 1100 configured to store data, a processor 1200 configured to control the sharing memory system 1100, and an Advanced eXtensible Interface (AXI) controller 1300.

The sharing memory system 1100 may operate in response to a control signal CSG of the processor 1200, and receive or output data through the AXI controller 1300. The sharing memory system 1100 may include volatile or nonvolatile memory cells in which data is stored. Data stored in the volatile memory cell may disappear when power supply is stopped. Data stored in the nonvolatile memory cell may be retained even when power supply is stopped. However, since each of the volatile memory cell and the nonvolatile memory cell has advantages and disadvantages in terms of operating speed, storage capacity, etc., the volatile memory cell and the nonvolatile memory cell may be selectively used depending on the use of the memory system 1000.

Although the memory system 1000 including volatile memory cells is described as an example in the following embodiment, the present disclosure is not limited to systems including only volatile memory cells.

The processor 1200 may generate a control signal CSG in response to a request RQ received from the host system 2000, and transmit the generated control signal CSG to the sharing memory system 1100. For example, when the processor 1200 receives data together with a program request, the processor 1200 may control the AXI controller 1300 and the sharing memory system 1100 such that the data is stored in the sharing memory system 1100. When the processor 1200 receives a read request from the host system 2000, the processor 1200 may control the AXI controller 1300 and the sharing memory system 1100 such that data read from the sharing memory system 1100 is output to the host system 2000.

Also, the processor 1200 may temporarily store data received through a bus B1 or B2 in a read or program operation, and distribute and transmit data according to a data width of each of the memory system 1000 and the host system 2000. For example, when assuming that the data width of a first bus B1 of the memory system 1000 is a first data width 1DW, information of the first data width 1DW may be pre-stored in the processor 1200. When assuming that the data width of a second bus B2 connected to the host system 2000 is a second data width 2DW, information of the second data width 2DW may be received from the host system 2000 when the memory system 1000 and the host system 2000 are connected to each other. That is, the first bus B1 may be used as an internal bus of the memory system 1000, and the second bus B2 may be used as an external bus connected to the host system 2000.

The first and second data widths 1DW and 2DW may be equal to or different from each other. Therefore, the processor 1200 may distribute data to be suitable for each of the first and second data widths 1DW and 2DW by mapping the data according to the first and second data widths 1DW and 2DW, and transmit the mapped data to be suitable for the first or second bus B1 or B2.

The AXI controller 1300 may transmit data between the sharing memory system 1100 and the host system 2000 under the control of the processor 1200. The AXI controller 1300 may be connected to each of the sharing memory system 1100 and the processor 1200 through the first bus B1.

The host system 2000 may transmit or receive data to or from the memory system 1000 through the second bus B2(HB).

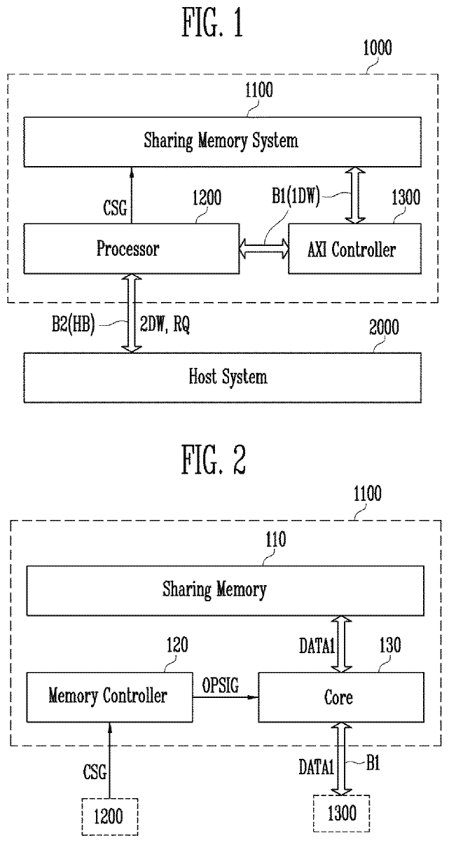

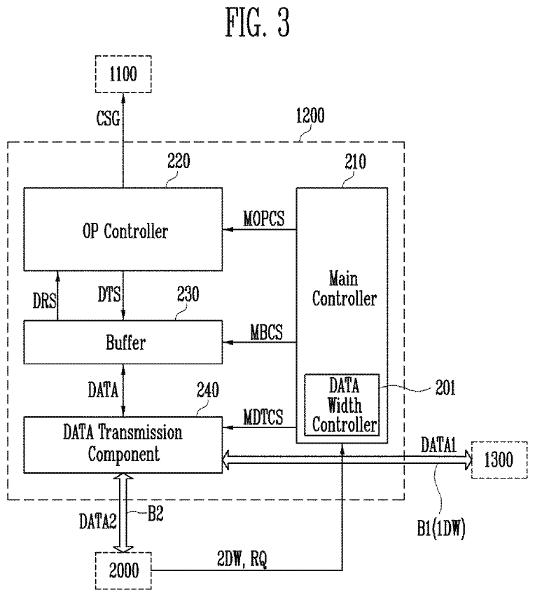

FIG. 2 is a diagram illustrating the sharing memory system shown in FIG. 1.

Referring to FIG. 2, the sharing memory system 1100 may include a sharing memory 110, a memory controller 120, and a core 130.

The sharing memory 110 may include a plurality of banks (not shown) in which data is stored, and the banks may include a plurality of volatile memory cells.

The memory controller 120 may output operation signals OPSIG in response to a control signal CSG received from the processor 1200. For example, when the memory controller 120 receive a control signal CSG for a program operation, the memory controller 120 may output operation signals OPSIG such that the program operation is performed according to a program algorithm. When the memory controller 120 receives a control signal CSG for a read operation, the memory controller 120 may output operation signals OPSIG such that the read operation is performed according to a read algorithm.

The core 130 may perform a program operation for storing first data DATA1 received from the AXI controller 1300 in the sharing memory 110 in response to the operation signals OPSIG for the program operation. The core 130 may read the sharing memory 110 in response to the operation signals OPSIG for the read operation, and transmit the read first data DATA1 to the AXI controller 1300 through the first bus B1.

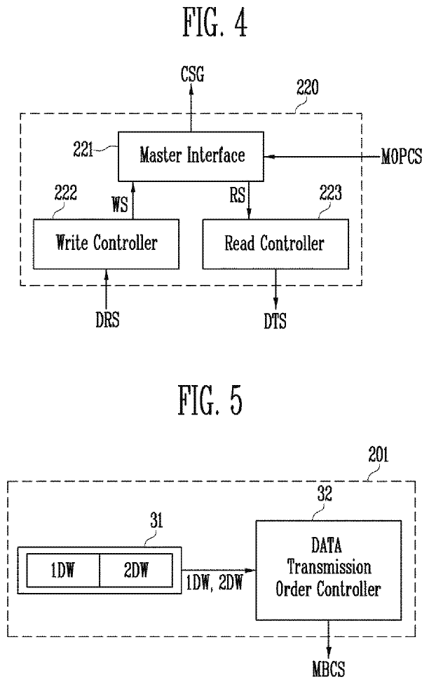

FIG. 3 is a diagram illustrating the processor shown in FIG. 1.

Referring to FIG. 3, the processor 1200 may include a main controller 210, an operation (OP) controller 220, a buffer 230, a data transmission component 240.

The main controller 210 may output main operation control signals MOPCS, main buffer control signals MBCS, and main data transmission control signals MDTCS in response to a request RQ received from the host system 2000. For example, the main operation control signals MOPCS may be signals for controlling the OP controller 220, the main buffer control signals MBCS may be signals for controlling the buffer 230, and the main data transmission control signals MDTCS may be signals for controlling the data transmission component 240.

In particular, the main controller 210 may include a data width controller 201 configured to distribute data according to data widths of the memory system 1000 and the host system 2000.

The data width controller 201 may output main buffer control signals MBCS according to the data widths of the memory system 1000 and the host system 2000. For example, the data width controller 201 may store information on the data widths of the memory system 1000 and the host system 2000, map data stored in the buffer 230 according to the stored information, and output main buffer control signals for outputting the mapped data according to an order.

The OP controller 220 may output a control signal CSG in response to the main operation signals MOPCS. For example, when main operation control signals MOPCS for a program operation are received, the OP controller 220 may output a control signal CSG for the program operation. When main operation control signals MOPCS for a read operation are received, the OP controller 220 may output a control signal for the read operation.

The buffer 230 may receive data from the data transmission component 240 in response to the main buffer control signals MBCS, map the received data, and output the mapped data to the data transmission component 240 according to an order. Also, in a program operation, when data to be programmed is stored in the buffer 230, the buffer 230 may output a data reception signal DRS to the OP controller 220. Also, in a read operation, when a data transmission signal DTS is received from the OP controller 220, the buffer 230 may receive data read in response to the main buffer control signals MBCS, map the received data, and output the mapped data according to an order.

The data transmission component 240 may transmit first data DATA1 received from the AXI controller 1300 to the buffer 230 in response to the main data transmission control signals MDTCS, or transmit data received from the buffer 230 to the AXI controller 1300 or the host system 200 in response to the main data transmission control signals MDTCS. For example, the data transmission component 240 may transmit/receive first data DATA1 to/from the AXI controller 1300 through the first bus B1, and transmit/receive second data DATA2 to/from the host system 2000 through the second bus B2. For example, the first data DATA1 may be data before the data is mapped by the data width controller 201, and the second data DATA2 may be data after the data is mapped by the data width controller 201.

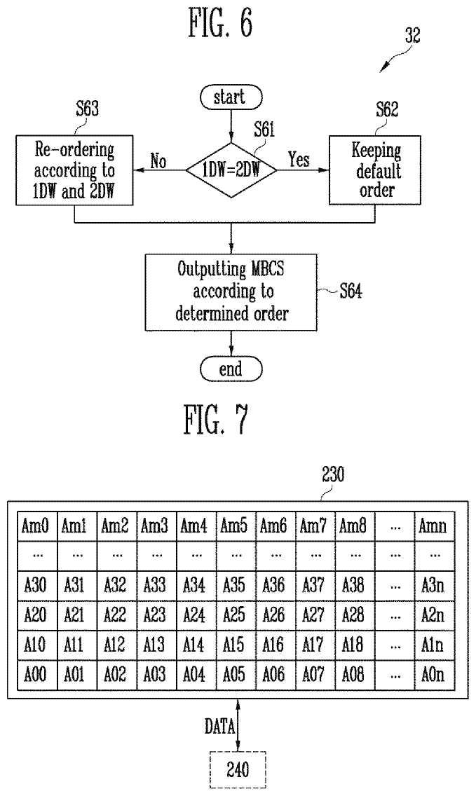

FIG. 4 is a diagram illustrating the OP controller shown in FIG. 3.

Referring to FIG. 4, the OP controller 220 may include a master interface 221, a write controller 222, and a read controller 223.

In a program operation, the master interface 221 may output a control signal CSG for performing the program operation in response to the main operation control signals MOPCS and a write signal WS. The write signal WS may be received from the write controller 222.

In a read operation, the master interface 221 may output a read signal RS for receiving data in response to the main operation control signals MOPCS. The read signal RS may be output to the read controller 223.

The write controller 222 may be activated in the program operation. When the data reception signal DRS representing that data have been received to the buffer 230 is received, the write controller 222 may generate the write signal WS, and output the generated write signal WS to the master interface 221.

The read controller 223 may be activated in the read operation. When the read signal RS is received, the read controller 223 may output the data transmission signal DTS to the buffer 230 to output read data stored in the buffer 230.

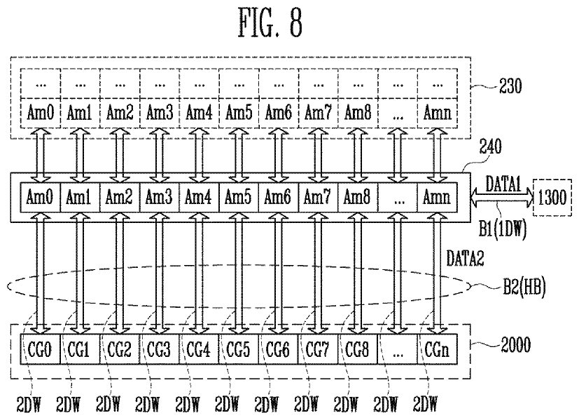

FIG. 5 is a diagram illustrating the data width controller shown in FIG. 3.

Referring to FIG. 5, the data width controller 201 may include a register 31 and a data transmission order controller 32.

The register 31 may store information on a first data width 1DW and a second data width 2DW. The first data width 1DW may be stored in a manufacturing phase of the memory system 1000, and the second data width 2DW may be received from the host system 2000 when the memory system 1000 and the host system 2000 are connected to each other.

That is, when the host system 2000 is connected to the memory system 1000, the host system 2000 may transmit the information on the second data width 2DW of the host system 2000 to the memory system 1000, and the memory system 1000 may store the received second data width 2DW in the register 31 of the data width controller 201.

The data transmission order controller 32 may receive the information on the first and second data widths 1DW and 2DW from the register 31, and output main buffer control signals MBCS by setting a data distribution order according to the received data widths. For example, the data transmission order controller 32 may compare the first and second data widths 1DW and 2DW with each other, and set a data distribution order, based on the comparison result. An order in which data received to the buffer 230 is output according to the order in which the data is received may be set as a default order in the data transmission order controller 32. When the first and second data widths 1DW and 2DW are equal to each other, the data transmission order controller 32 may output the main buffer control signals MBCS according to the default order. In an embodiment, the default order may be preset in the data transmission order controller. The word “preset” as used herein with respect to a parameter, such as a preset order, means that a value for the parameter is determined prior to the parameter being used in a process or algorithm. For some embodiments, the value for the parameter is determined before the process or algorithm begins. In other embodiments, the value for the parameter is determined during the process or algorithm but before the parameter is used in the process or algorithm. When the first and second data widths 1DW and 2DW are not equal to each other, the data transmission order controller 32 may map data stored in the buffer 230, and output the main buffer control signals MBCS by newly setting the order in which the mapped data is output.

The above-described operating method of the data transmission order controller 32 will be described in below as follows.

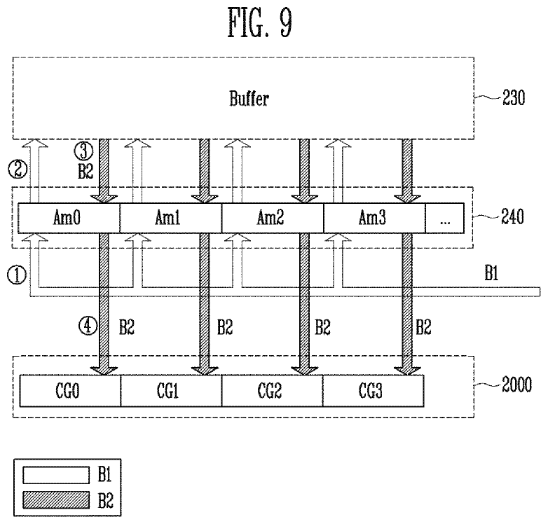

FIG. 6 is a diagram illustrating an operating method of the data transmission order controller shown in FIG. 5.

Referring to FIG. 6, the data transmission order controller 32 compares a first data width 1DW of the first bus B1 and a second data width 2DW of the second bus B2, which are stored in the register 31 (S61).

As the comparison result, when the first data width 1DW and the second data width 2DW are equal to each other (Yes), the data transmission order controller 32 sets a data transmission order as a default order (S62). The default order is a basic order pre-stored in the data transmission order controller 32. The default order may be an order in which, after data is sequentially input to the buffer 230, the data is sequentially output from the buffer 230 according to the order in which the data is input.

In the step S61, when the first data width 1DW and the second data width 2DW are not equal to each other (No), the data transmission order controller 32 may reset the data transmission order according to the first and second data widths 1DW and 2DW (S63).

When a data transmission order is determined in the steps S62 or S63, the data transmission order controller 32 outputs main buffer control signals MBCS according to the determined data transmission order (S64).

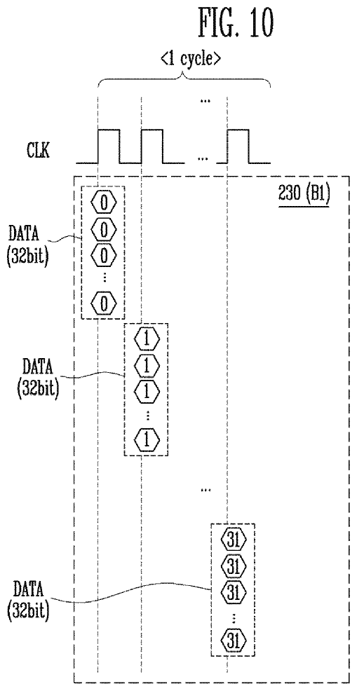

FIG. 7 is a diagram illustrating the buffer shown in FIG. 3.

Referring to FIG. 7, the buffer 230 may include a plurality of blocks A00 to Amn (m and n are positive integers) in which data DATA can be temporarily stored. The blocks A00 to Amn may transmit/receive the data DATA to/from the data transmission component 240 through the first or second bus B1 or B2. A data width of each of the blocks A00 to Amn may be equal to that of at least one of the first and second buses B1 and B2.

In a program operation, the buffer 230 may temporarily store program data received from the host system 2000 through the data transmission component 240, and then transmit the temporarily stored data to the AXI controller 1300 through the data transmission component 240. Also, in a read operation, the buffer 230 may temporarily store read data received from the AXI controller 1300 through the data transmission component 240, and then output the temporarily stored data to the host system 2000 through the data transmission component 240.

For example, in the read operation, read data read from the sharing memory system 1100 may be sequentially input to the buffer 230 through the AXI controller 1300 and the data transmission component 240. For example, the data input to the buffer 230 may be sequentially input to the blocks A00 to Amn. The data is not input to all the blocks A00 to Amn, but may be input some blocks among the blocks A00 to Amn according to a data width. Blocks to which the data is input among the blocks A00 to Amn may be mapped in response to the main buffer control signals MBCS output from the data transmission order controller 32 shown in FIG. 5, and the data of the blocks mapped to each other may be simultaneously output to the data transmission component 240.

A configuration of the data transmission component 240 will be described below as follows.

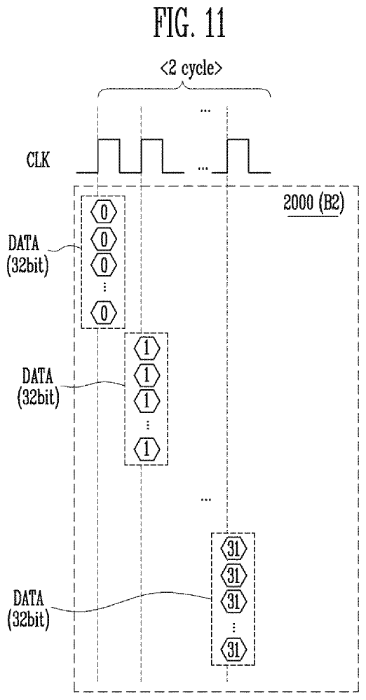

FIG. 8 is a diagram illustrating the data transmission component shown in FIG. 3.

Referring to FIG. 8, the data transmission component 240 may include a plurality of transmission blocks. The plurality of transmission blocks may transmit data between the buffer 230 and the AXI controller 1300 or the host system 2000. For example, each of the plurality of transmission blocks may be connected to the AXI controller 1300 through the first bus B1, and be connected to the host system 2000 through the second bus B2. Also, each of the plurality of transmission blocks may be connected to the buffer 230 through the first and second buses B1 and B2.

For example, when first data DATA1 is received from the AXI controller 1300, the plurality of transmission blocks of the data transmission component 240 may transmit the first data DATA1 respectively to blocks Am0 to Amn of the buffer 230. That is, the plurality of transmission blocks included in the data transmission component 240 may be respectively connected to the blocks Am0 to Amn included in the buffer 230, and blocks mapped to each other among the blocks Am0 to Amn included in the buffer 230 may transmit data respectively to the transmission blocks of the data transmission component 240. The transmission blocks of the data transmission component 240 may transmit second data DATA2 received from the buffer 230 to the host system 2000 through the second bus B2.

The host system 2000 may include computing engine groups CG0 to CGn (n is a positive integer) connected to the second bus B2 to transmit/receive data to/from the memory system 1000. Each of the computing engine groups CG0 to CGn may be implemented with a buffer, and have a data width equal to the second data width 2DW of the second bus B2.

The above-described connection configuration and data transmission order among the buffer 230, the data transmission component 240, and the host system 2000 will be described below as follows.

FIG. 9 is a diagram illustrating a data transmission order in accordance with an embodiment of the present disclosure.

Referring to FIG. 9, the buffer 230 may be connected to the data transmission component 240 through first and second buses B1 and B2. The data transmission component 240 may be connected to the AXI controller 1300 through the first bus B1, and be connected to the host system 2000 through the second bus B2. A case where the first bus B1 has a first data width 1DW and the second bus B2 has a second data width 2DW is assumed.

For example, in a read operation, data output from the AXI controller 1300 may be transmitted to the data transmission component 240 through the first bus B1 (\textcircled{1}). Therefore, data having the first data width 1DW may be input to each of transmission blocks Am0 to Am3, . . . of the data transmission component 240. The data input to the data transmission component 240 may be transmitted to the buffer 230 through the first bus B1 (\textcircled{2}). As described above, a plurality of blocks are included in the buffer 230, blocks to which the data is input may be mapped according to the first and second data widths 1DW and 2DW. The data of the mapped blocks may be transmitted to the data transmission component 240 through the second bus B2 (\textcircled{3}), and the data transmission component 240 may output the data to computing engine groups CG0 to CG3, . . . of the host system 2000 through the second bus B2 (\textcircled{4}).

In order to more easily understand the described-above data transmission order, the data transmission order will be described as follows by using the buffer 230 and the host system 2000.

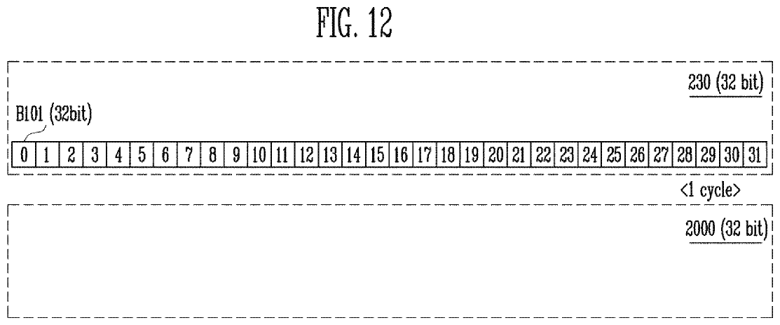

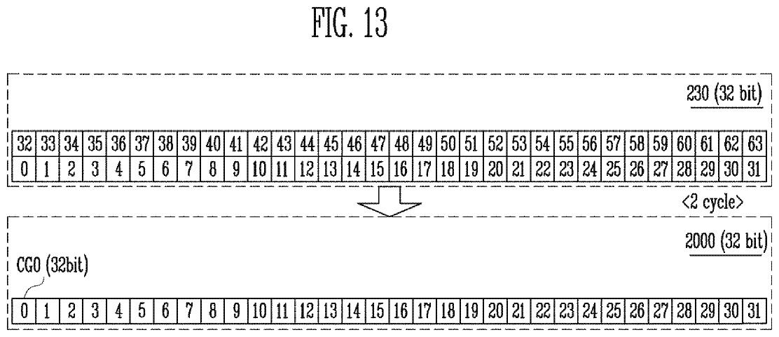

FIGS. 10 and 11 are diagrams illustrating a data transmission method in accordance with a first embodiment of the present disclosure. An embodiment when data widths of the first and second buses B1 and B2 are equal to each other will be described. As described above, when the data widths of the first and second buses B1 and B2 are equal to each other, the data transmission order controller 32 shown in FIG. 5 may maintain a data transmission order as a default order.

FIG. 10 illustrates data input to the buffer 230, and FIG. 11 illustrates data output from the buffer 230 to be input to the host system 2000. A case where each of the data widths of the first and second buses B1 and B2 corresponds to 32 bits will be described as an example.

Referring to FIG. 10, data DATA (0, 1, . . . , and 31) read from the sharing memory system may be input to the buffer 230 through the AXI controller and the data transmission component. When the data width of the first bus B1 corresponds to 32 bits, 32-bit data may be simultaneously input to a block of the buffer 230 for each clock CLK. For example, when each of data 0 DATA 0, data 1 DATA 1, and data 31 DATA 31 is configured as 32-bit data, the 32-bit data 0 DATA 0 may be input to the block of the buffer 230 in response to a first rising edge of the clock, and the 32-bit data 1 DATA 1 may be input to another block of the buffer 230 in response to a second rising edge of the clock. In this manner, the 32-bit data 31 DATA 31 may be input to the block of the buffer 230 in response to a rising edge of the clock. Therefore, a phase in which data having the maximum capacity, which can be transmitted through the first bus B1, are input to the buffer 230 in response to a plurality of clocks CLK is referred to as one cycle.

That is, the capacity of data input to the buffer 230 through the first bus B1 during a first cycle (1 cycle) is limited. The limitation may be increased or decreased according to the first data width 1WD of the first bus B1.

Referring to FIG. 11, in a second cycle (2 cycle), data input to the buffer 230 may be output to the host system 2000 through the second bus B2. In FIG. 11, the data width of the second bus B2 corresponds to 32 bits, and therefore, the data may be output to the host system 2000 in response to the clock according to the order in which the data were input to the buffer 230.

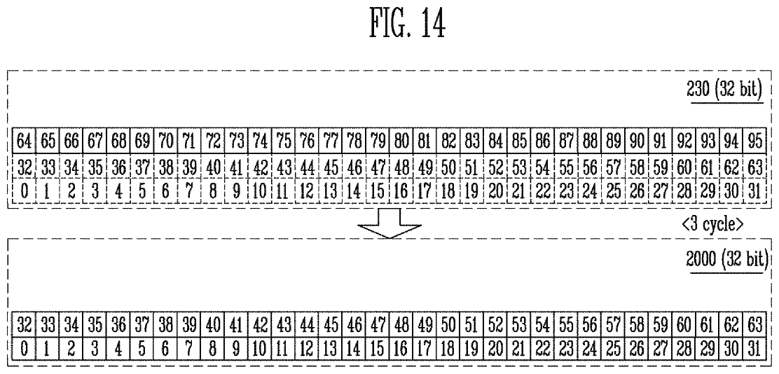

FIGS. 12 to 14 are diagram illustrating a data mapping and transmission method by using the buffer and the host system in accordance with the first embodiment of the present disclosure.

Referring to FIG. 12, during the first cycle (1 cycle), 32-bit data may be input to each of blocks of the buffer 230. For example, when a first block B101 has a data width of 32 bits, 32-bit data ‘0’ may be input to the first block B101 through the first bus B1.

The first cycle (1 cycle) is a period in which data is input to the buffer 230, and hence no data is input to the host system 2000 during the first cycle (1 cycle).

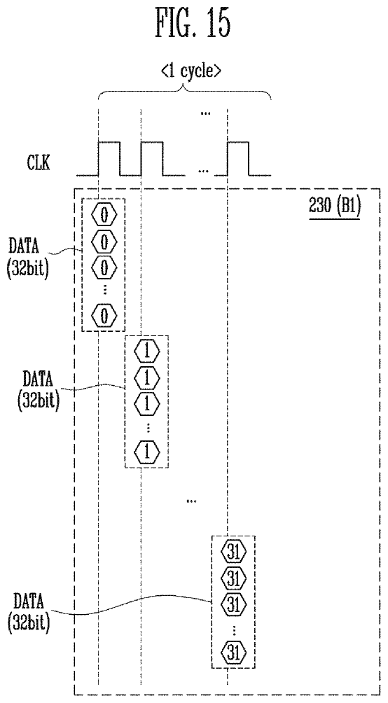

Referring to FIG. 13, in the second cycle (2 cycle), data 0 to 31 input to the buffer 230 in the first cycle may be output to the host system 2000, and new data 32 to 63 may be input to the buffer 230.

In the first embodiment, the data widths of the block B101 of the buffer 230 and the computing engine block CG0 of the host system 2000 are equal to each other as 32 bits, and therefore, the data 0 to 31 input to the buffer 230 may be output to the host system 2000 as they are. That is, 32-bit data input to one block in the buffer 230 may be transmitted to one 32-bit computing engine block as they are.

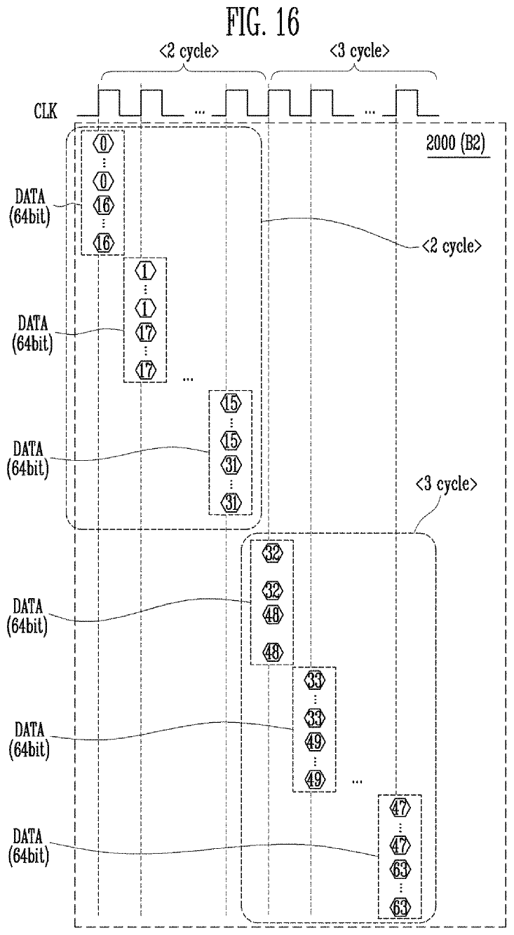

Referring to FIG. 14, in a third cycle (3 cycle), the data 32 to 63 input to the buffer 230 in the second cycle may be output to the host system 2000, and new data 64 to 95 may be input to the buffer 230.

Next, an embodiment when the data widths of the first and second buses B1 and B2 are different from each other will be described.

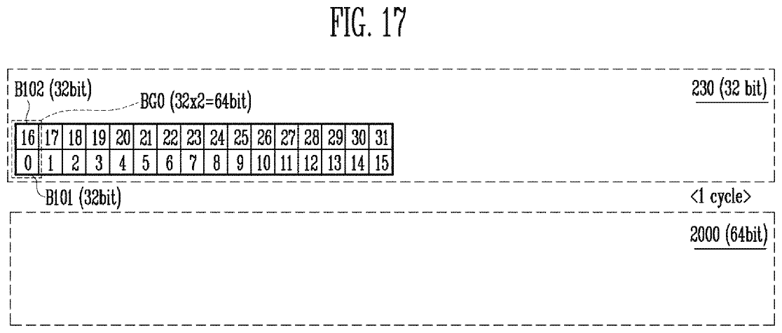

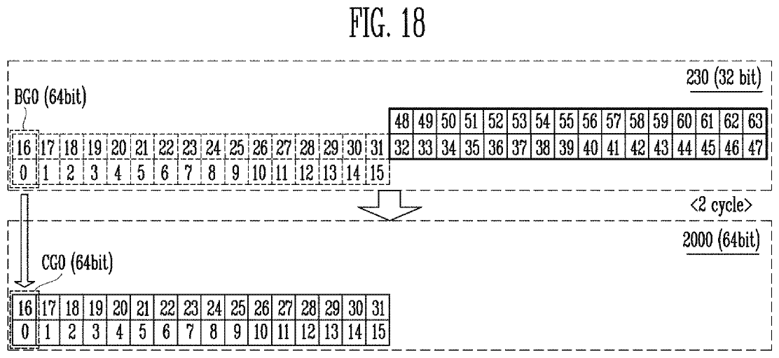

FIGS. 15 and 16 are diagrams illustrating a data transmission method in accordance with a second embodiment of the present disclosure. An embodiment when the second bus B2 has a data width greater than that of the first bus B1 will be described. In the second embodiment, the data width of the second bus B2 through which data is output is greater than that of the first bus B1 through which read data is input, and therefore, the data transmission order controller 32 shown in FIG. 5 may map blocks to which data is input in the buffer 230 according to the data width of the second bus B2. Blocks mapped as the same group may be consecutive blocks or blocks to which related data is input.

FIG. 15 illustrates data input to the buffer 230, and FIG. 16 illustrates data output from the buffer 230 to be input to the host system 2000. A case where the data width of the first bus B1 corresponds to 32 bits and the data width of the second bus B2 corresponds to 64 bits will be described as an example.

Referring to FIG. 15, data DATA (0, 1, . . . , 31) read from the sharing memory system may be input to buffer 230 through the AXI controller and the data transmission component. When the data width of the first bus B1 corresponds to 32 bits, 32-bit data may be simultaneously input to a block of the buffer 230 for each clock CLK. For example, when each of data 0 DATA 0, data 1 DATA 1, and data 31 DATA 31 is configured as 32-bit data, the 32-bit data 0 DATA 0 may be input to the block of the buffer 230 in response to a first rising edge of the clock, and the 32-bit data 1 DATA 1 may be input to another block of the buffer 230 in response to a second rising edge of the clock. In this manner, the 32-bit data 31 DATA 31 may be input to the block of the buffer 230 in response to a rising edge of the clock. That is, during a first cycle (1 cycle), data 0 to 31 may be input to blocks of the buffer 230.

Since a data width of output data is greater than that of input data, the data transmission order controller 32 shown in FIG. 5 may map blocks to which data is input in the buffer 230 to be suitable for the data width of the second bus B2. For example, since the data width of the second bus B2 corresponds to 64 bits, the data transmission order controller 32 may map the blocks to which the data is input in the buffer 230 two by two, and simultaneously output the data input to the mapped blocks from a second cycle (2 cycle).

Referring to FIG. 16, in the second cycle (2 cycle), the data of the mapped blocks in the buffer 230 may be simultaneously output to the host system 2000 through the second bus B2. As described with reference to FIG. 15, since two blocks are mapped to each other in the buffer 230, the mapped blocks have a data width of 64 bits. For example, blocks to which data 0 and data 16 are input in the buffer 230 may be mapped as one group. Since the data 0 input to one block in the buffer 230 has a data width of 32 bits and the data 16 input to another block in the buffer 230 has a data width of 32 bits, the total data capacity of the blocks to which the data 0 and the data 16 are input becomes 64 bits. In this manner, blocks to which data 1 and data 17 are input may be mapped as one group, and blocks to which data 15 and data 31 are input may be mapped as one group.

The buffer 230 may sequentially output 64-bit data of the blocks mapped as described above through the second bus B2, and the host system 2000 may store the 64-bit data in one computing engine group.

For example, during the second cycle, the data 0 and the data 16 may be simultaneously input to the host system 2000 in response to one clock CLK, and the data 1 and the data 17 may be simultaneously input to the host system 2000 in response to a next clock CLK. When the data 0 to 31 input to the buffer 230 during the first cycle are all output to the host system 2000 during the second cycle, data 32 to 63 may be input to the buffer 230. The data 32 to 63 input to the buffer 230 during the second cycle may also be output to the host system 2000 during a third cycle (3 cycle).

FIGS. 17 to 19 are diagram illustrating a data mapping and transmission method by using the buffer and the host system in accordance with the second embodiment of the present disclosure.

Referring to FIG. 17, during the first cycle (1 cycle), 32-bit data may be input to each of the blocks of the buffer 230. For example, when the first block B101 has a data width of 32 bits, 32-bit data ‘0’ may be input to the first block B101 through the first bus B1.

The first cycle (1 cycle) is a period in which data is input to the buffer 230, and hence no data is input to the host system 2000 during the first cycle (1 cycle).

Each of the data 0 to 31 input to the buffer 230 may be stored by 32 bits in a block. That is, since each of the blocks included in the buffer 230 stores 32-bit data, the data transmission order controller 32 may map blocks to which data is input such that the total data capacity of blocks becomes 64 bits. For example, the block B101 to which the data 0 is input and a block B102 to which the data 16 is input may be mapped to each other, thereby constituting one block group BG0.

Referring to FIG. 18, in the second cycle (2 cycle), the data 0 to 31 input to the buffer 230 in the first cycle may be output to the host system 2000, and new data 32 to 63 may be input to the buffer 230.

Since the data widths of the buffer group BG0 and the computing engine block CG0 of the host system 2000 are equal to each other as 64 bits, data of each of the mapped blocks in the buffer 230 may be simultaneously output to the host system 2000.

That is, since data of a 32-bit block is to be transmitted to the 64-bit computing engine block CG0 before the blocks are mapped in the buffer 230, the number of channels of unused buses increases, and therefore, buses may be wasted. However, in the second embodiment, the blocks of the buffer 230 are mapped to be suitable for the data width of the computing engine block CG0, and data of the mapped blocks are simultaneously output. Thus, waste of buses can be prevented, and the operating speed of the memory system can be improved.

While the data 0 to 31 of the buffer 230 are being transmitted to the host system 2000 in the second cycle, next data 32 to 63 may be newly input to the buffer 230. Blocks to which the data 32 to 63 are input may be mapped two by two to be suitable for 64 bits.

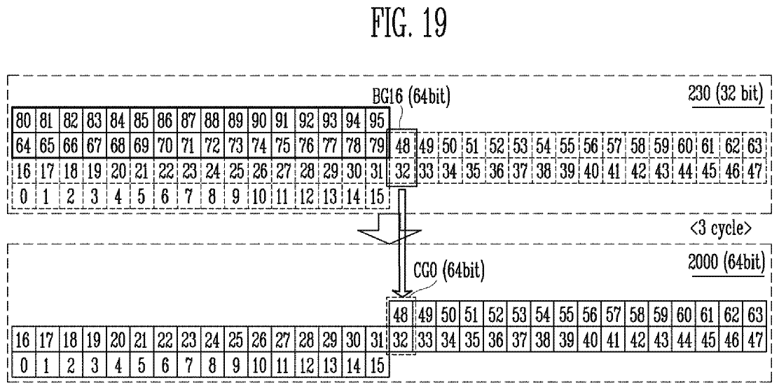

Referring to FIG. 19, in the third cycle (3 cycle), the data 32 to 63 input to the buffer 230 in the second cycle may be output to the host system 200, new data 64 to 95 may be output to the buffer 230, and blocks to which the data 64 to 95 are input may be mapped to each other two by two. For example, when two blocks to which data 32 and 48 are input in the buffer 230 are mapped to each other, the data 32 and 48 may be transmitted to one computing engine group CG0. The computing engine group CG0 corresponds to one buffer block included in the host system 2000. That is, data stored in two blocks in the buffer 230 may be output to one computing engine group included in the host system 2000.

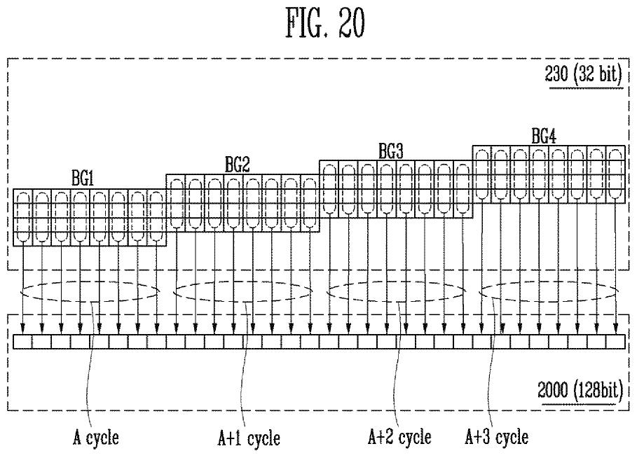

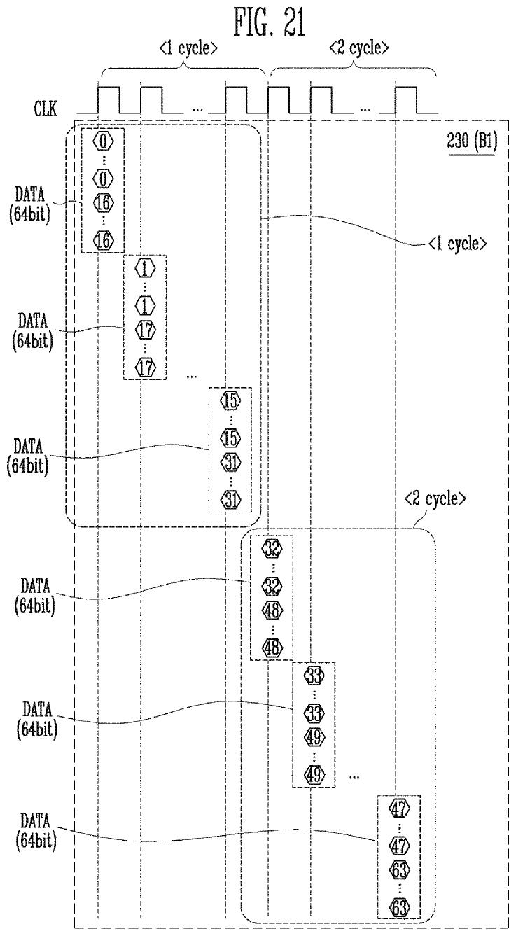

FIG. 20 is a diagram illustrating a data mapping and transmission method by using the buffer and the host system in accordance with a third embodiment of the present disclosure.

Referring to FIG. 20, in the third embodiment, a case where each of the blocks included in the buffer 230 receives read data having a data width of 32 bits and each of the computing engine groups included in the host system 2000 receives read data having a data width of 128 bits is assumed.

The data transmission order controller 32 may map four 32-bit blocks included in the buffer 230 such that the blocks have a data width of 128 bits. Block groups BG1 to BG4 may be output to the host system 2000 in different cycles.

For example, during an Ath cycle (A cycle), data input to a first buffer group BG1 may be output by 128 bits to the computing engine groups of the host system 2000, and next data may be input to blocks of a second buffer group BG2.

During an (A+1)th cycle (A+1 cycle), the data input to the blocks of the second buffer group BG2 may be output by 128 bits to the computing engine groups of the host system 2000, and next data may be input to blocks of a third buffer group BG3.

In this manner, during (A+2)th and (A+3)th cycles (A+2 and A+3 cycles), data may be input/output to/from the buffer 230, and data may be input to the host system 2000.

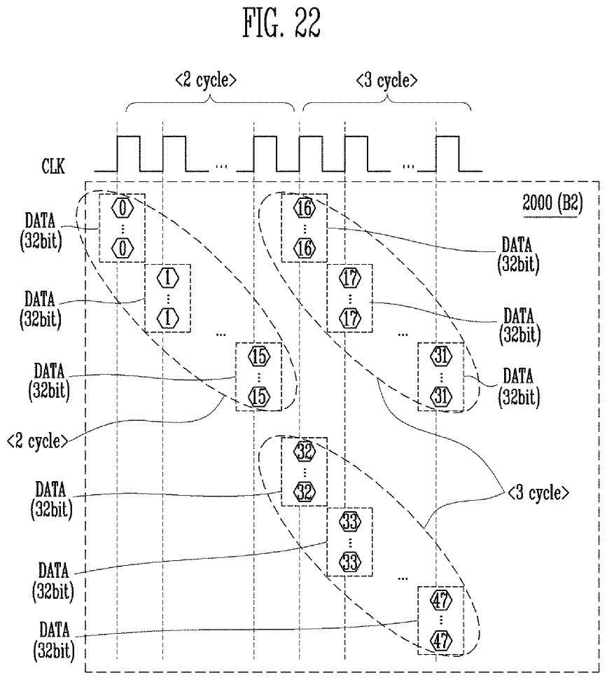

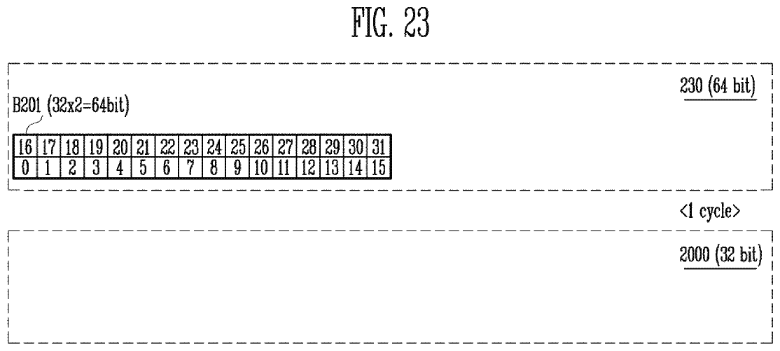

FIGS. 21 and 22 are diagrams illustrating a data transmission method in accordance with a fourth embodiment of the present disclosure.

Referring to FIGS. 21 and 22, a case where the host system 2000 has a data width smaller than that of the buffer 230 is illustrated as the fourth embodiment.

For example, a case where each of the blocks included in the buffer 230 has a data width of 64 bits and each of the computing engine groups of the host system 2000 has a data width of 32 bits is assumed.

During a first cycle (1 cycle), 64-bit data groups may be sequentially input in response to a clock CLK. For example, data 0 and 16 may be input to one block in response to a first clock CLK, and data 1 and 17 may be input to another block in response to a second clock CLK. However, each of the data 0 and the data 16 is 32-bit data, and the data 0 and the data 16 are distinguished from each other so as to describe that data is divided by 32 bits to be output to the host system 2000. The data 0 and the data 16 may be expressed as 64-bit data 0 without such distinguishment. When the data 0 and the data 16 are expressed as 64-bit data 0, the data 0 may be divided into two 32-bit data groups, and the data groups may be sequentially output to the host system 2000 from a next cycle. In order to help understanding of the present disclosure, in FIGS. 21 and 22, data simultaneously input to the buffer 230 in response to one clock CLK will be designated as two groups.

When data 0 to 31 are input to the buffer 230 during the first cycle (1 cycle), data 32 to 63 may be input to the buffer 230 in response to a clock CLK during a second cycle (2 cycle). In the second cycle (2 cycle), data 32 and 48 may be input to one block in response to one clock CLK, and data 33 and 49 may be input to another block in response to a next clock CLK.

Referring to FIG. 22, during the second cycle (2 cycle), data 0, 1, . . . , and 15 corresponding to ½ among data input to the respective block of the buffer 230 may be sequentially output in response to a clock CLK. The data 0, 1, . . . , and 15 output from the buffer 230 may be input to each of the computing engine groups of the host system 2000. Since it has been assumed that each of the computing engine groups has a data width of 32 bits, the data 0 has a data width of 32 bits, and the data 1 has a data width of 32 bits.

In a third cycle (3 cycle), data 16 to 47 input to the buffer 230 are output in response to a clock CLK. Data 16 and data 32 may be simultaneously output in response to the same clock CLK, and be input to different computing engine groups. The reason why the data 16 and the data 32 can be simultaneously output is that the data 16 and the data 32 are input to different blocks in the buffer 230. According to such a principle, data 17 and data 33 may be simultaneously output in response to a next clock CLK to be input to different computing engine groups.

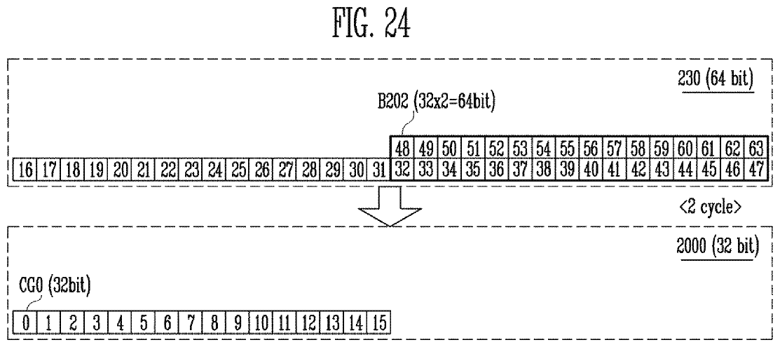

FIGS. 23 to 25 are diagrams illustrating a data mapping and transmission method by using the buffer and the host system in accordance with the fourth embodiment of the present disclosure.

Referring to FIG. 23, during the first cycle (1 cycle), 64-bit data may be sequentially input to the buffer 230. For example, the total data capacity of the data 0 and 16 may be 64 bits, and the 64-bit data 0 and 16 may be simultaneously input to one block. That is, data 1 and 17 are data simultaneously input to the same block, and data 2 and 18 are data simultaneously input to the same block. The block to which the data 1 and 17 are input is different from that to which the data 2 and 18 are input.

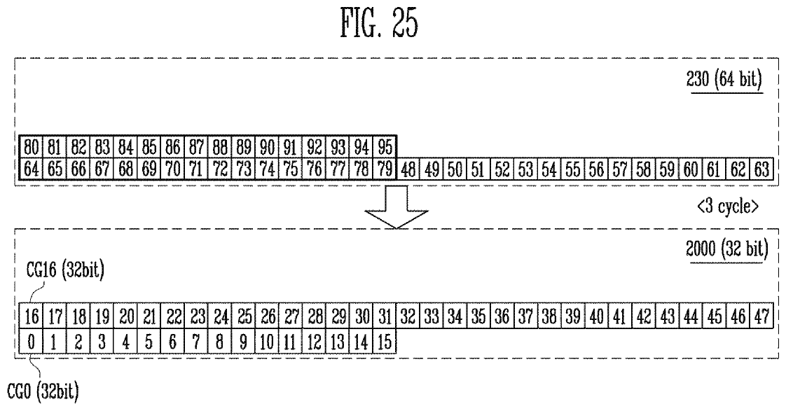

Referring to FIG. 24, during the second cycle (2 cycle), ½ of data input to the buffer 230 may be output to the host system 2000. For example, data 0 to 15 among the data 0 to 31 input to the buffer 230 during the first cycle (1 cycle) may be output to the host system 2000. However, the data 0 to 15 may be data input to different blocks in the buffer 230, and be input to different computing engine groups in the host system 2000. For example, the 32-bit data 0 may be input to the computing engine group CG0.

In addition, when the data 0 to 15 are output to the host system 2000, data 32 to 63 may be input to the buffer 230. The data 32 to 63 may be input to blocks different from those to which the data 0 to 31 are input in the buffer 230. The data 32 to 63 may form pairs of 64-bit data to be input to the buffer 230. For example, data 32 and 48 may form 64-bit data, and be simultaneously input to the same block. Also, data 33 and 49 may form 64-bit data, and be simultaneously input to the same block. The block to which the data 32 and 48 are input is different from that to which the data 33 and 49 are input.

Referring to FIG. 25, in the third cycle (3 cycle), data 16 to 31 remaining in the buffer 230 among the data input in the first cycle (1 cycle) and data 32 to 47 corresponding to ½ of the data input to the buffer 230 during the second cycle (2 cycle) may be output to the host system 2000.

For example, each of the data 16 to 31 may be configured as 32-bit data, and each of the data 32 to 47 may be configured as 32-bit data. That is, each of the data 16 to 47 may be configured as 32-bit data, and be input to different computing engine groups of the host system 2000. Therefore, the data 0 and the data 16 are stored in the same block in the buffer 230, but may be respectively stored in different computing engine groups CG0 and CG16 in the host system 2000.

As described above, blocks in which data is stored are mapped according to a data width, and the mapped blocks are transmitted to be suitable for the data width, so that buses having various data width can be used in the memory system. Further, although the memory system 1000 is connected to the host system 2000 having a data with different from that thereof, buses can be effectively used.

While the present disclosure has been shown and described with reference to certain examples of embodiments thereof, it will be understood by those skilled in the art that various changes in form and details may be made therein without departing from the spirit and scope of the present disclosure as defined by the appended claims and their equivalents. Therefore, the scope of the present disclosure should not be limited to the above-described examples of embodiments but should be determined by not only the appended claims but also the equivalents thereof.

In the above-described embodiments, all steps may be selectively performed or part of the steps and may be omitted. In each embodiment, the steps are not necessarily performed in accordance with the described order and may be rearranged. The embodiments disclosed in this specification and drawings are only examples to facilitate an understanding of the present disclosure, and the present disclosure is not limited thereto. That is, it should be apparent to those skilled in the art that various modifications can be made on the basis of the technological scope of the present disclosure.

Meanwhile, the examples of embodiments of the present disclosure have been described in the drawings and specification. Although specific terminologies are used here, those are only to explain the embodiments of the present disclosure. Therefore, the present disclosure is not restricted to the above-described embodiments and many variations are possible within the spirit and scope of the present disclosure. It should be apparent to those skilled in the art that various modifications can be made on the basis of the technological scope of the present disclosure in addition to the embodiments disclosed herein.

What is claimed is:

1. A memory system comprising:
a memory controller configured for storing data and transmitting data between the memory system and a host system, the memory controller comprising:
a buffer including a plurality of blocks configured for storing the data, the buffer configured for inputting or outputting the data through a first bus having a first data width or a second bus having a second data width; and
a data width controller configured to map the blocks according to the first and second data widths.

2. The memory system of claim 1, wherein the buffer:
stores the data input through the first bus in the blocks; and
when the blocks in which the data is stored are mapped by the data width controller, outputs the data stored in the mapped blocks through the second bus.

3. The memory system of claim 1, wherein the data width controller includes:
a register configured to store information on the first and second data widths; and
a data transmission order controller configured to compare the first and second data widths with each other, and output a main buffer control signal for mapping the blocks, based on the comparison result.

4. The memory system of claim 3, wherein the first bus is used as an internal bus of the memory controller, and
the second bus is used as an external bus connected to the host system.

5. The memory system of claim 3, wherein the data transmission order controller:
when the first and second data widths are equal to each other, outputs the main buffer control signal according to a default order preset in the data transmission order controller; and
when the first and second data widths are different from each other, outputs the main buffer control signal to map the blocks according to the first and second data widths.

6. The memory system of claim 5, wherein, when the default order is selected, the data transmission order controller does not map the blocks, and outputs the data input through the first bus through the second bus without mapping the data input through the first bus.

7. The memory system of claim 5, wherein, when the blocks are mapped, the data transmission order controller maps the blocks in different orders with respect to when the first data width is less than the second data width and when the first data width is greater than the second data width.

8. The memory system of claim 7, wherein, when the first data width is less than the second data width, the data transmission order controller maps the blocks in which the data is stored among the blocks included in the buffer according to the second data width, and outputs the main buffer control signal such that data stored in the mapped blocks different from each other are simultaneously output through the second bus.

9. The memory system of claim 7, wherein, when the first data width is greater than the second data width, the data transmission order controller divides and maps the blocks in which the data is stored among the blocks included in the buffer according to the second data width, and outputs the main buffer control signal such that data of the divided and mapped blocks are sequentially output through the second bus.

10. A memory system comprising:
a sharing memory system configured to store data;
a processor configured to control the sharing memory system in response to a request received from a host system, and store program data or read data; and
an Advanced eXtensible Interface (AXI) controller configured to transmit and receive data to and from the sharing memory system and the processor through a first bus,
wherein the processor:
is connected to the host system through a second bus; and
changes a transmission order of the program data or the read data according to data widths of the first and second buses.

11. The memory system of claim 10, wherein the processor includes:
an operation controller configured to output a control signal for performing an operation corresponding to the request in response to main operation control signals;
a data transmission component configured to transmit and receive data to and from the host system or the AXI controller in response to main data transmission control signals;
a buffer configured to receive data from the data transmission component in response to main buffer control signals, and transmit the received data to the host system or the AXI controller through the data transmission component; and
a main controller configured to output the main operation control signals, the main data transmission control signals, and the main buffer control signals in response to the request.

12. The memory system of claim 11, wherein the main controller includes a data width controller configured to map blocks included in the buffer according to the data widths of the first and second buses, and change an output order of the program data or the read data, which is stored in the mapped blocks.

13. The memory system of claim 12, wherein the data width controller includes:
a register configured to store information on the data widths of the first bus and the second bus; and
a data transmission order controller configured to compare the data widths of the first and second buses with each other, and change the output order of the program data or the read data, based on the comparison result.

14. The memory system of claim 13, wherein the data transmission order controller:
when the data widths of the first and second buses are equal to each other, determines the transmission order of the program data or the read data according to a default order preset in the data transmission order controller; and
when the data widths of the first and second buses are different from each other, determines the transmission order such that the program data or the read data is grouped or divided to be output according to the data widths of the first and second buses.

15. The memory system of claim 11, wherein the buffer includes a plurality of blocks for storing the program data or the read data according to a data width.

16. The memory system of claim 15, wherein each of the blocks has a data width equal to that of any one of the first and second buses.

17. The memory system of claim 16, wherein the first bus is used as an internal bus of the memory system, and
the second bus is used as an external bus connected to the host system.

18. The memory system of claim 17, wherein, when data input through the first bus is output through the second bus,
blocks in which data is stored among the blocks are mapped, and the data stored in the mapped blocks are simultaneously output through the second bus, when the data width of the first bus is less than that of the second bus, and
the data stored in the blocks is divided to be output through the second bus, when the data width of the first bus is greater than that of the second bus.

19. The memory system of claim 10, wherein, when the first bus is used as an internal bus of the memory system and the second bus is used as an external bus connected to the host system,
information on the data width of the first bus is pre-stored in the processor, and
information on the data width of the second bus is received from the host system, when the host system and the memory system are connected to each other.
